(19) United States
(12) Patent Application Publication
(10) Pub. No.: US 2007/0056908 A1
(43) Pub. Date: Mar. 15, 2007

(54) Nucleic acids in the form of specific novel chiral selectors

(75) Inventors: Eric Peyrin, Saint Egreve (FR); Annick Villet, La Tronche (FR); Catherine Grosset, Grenoble (FR); Anne Ravel, Jarric (FR); Eric Jourdan, Voreppe (FR)

Correspondence Address: OLIFF & BERRIDGE, PLC, P.O. BOX 19928, ALEXANDRIA, VA, 22320, US

(73) Assignee: Universite Joseph Fourier, Saint-Martin d'Heres (FR)

(21) Appl. No.: 10/559,289

(22) PCT Filed: Jun. 4, 2004
(86) PCT No.: PCT/FR04/01392

§ 371 Date: Feb. 1, 2006

(30) Foreign Application Priority Data
Jun. 5, 2003 (FR) 03/06809

(51) Int. Cl. B01D 15/08; C12Q 1/68

(52) U.S. Cl. 210/656; 210/198.2; 435/6

(57) ABSTRACT

The invention relates to chiral separation chromatographic and electrophoretic techniques. The aim of said invention is to obtain chiral stationary and mobile phases comprising an oligonucleotide which is specifically selected by a SELEX method against an enantiomer to be separated as a special-purpose chiral selector. Methods for separating enantiomers by the chiral stationary and mobile phases are also disclosed.

The present invention relates to chromatographic and electrophoretic techniques for separating optical isomers. A subject of the invention is the use of oligonucleotides as novel “tailor-made” chiral selectors.

The separation of optical isomers or enantiomers is considered to be one of the most difficult analytical problems to solve. Chromatographic and electrophoretic chiral separation techniques constitute, at the current time, the methods of choice for the separation, purification and quantification of enantiomers. The ability of the chiral selector to recognize its target with high specificities and affinities is the basis of the effectiveness of these methods of separation.

Thus, one of the major problems of the separation of enantiomers lies in the fact that there is no simple rule for choosing the selector according to the structure of the compounds to be separated. The choice of the chiral stationary phase (in chromatography) or of the chiral selector dissolved in the migration buffer (in capillary electrophoresis) for separating enantiomers is as a general rule made empirically, according to the existing data for similar molecules.

Novel research approaches have been explored in order to develop tools for molecular recognition capable of displaying high specificities and affinities. Among these, the use of “imprinted” molecules (Sellergren, B. J. Chromatogr. A 2001, 906, 227; Hwang, C. C., Lee, W. C. J. Chromatogr. B 2001, 765, 45; Hart, B. R., Rush, D. J.; Shea, K. J. J. Am. Chem. Soc. 2000, 122, 460; Mayes, A. G.; Mosbach, K. Anal. Chem. 1996, 68, 3769; Sellergren, B. Shea, K. J. J. Chromatogr. A 1995, 690, 29) and of antibodies constitutes a recent major advance (Hofstetter, O., Lindstrom, H., Hofstetter, H. Anal. Chem. 2002, 74, 2119; Nevanen, T. K., Soderholm, L., Kukkonen, K., Suortti, T., Teerinen, T.; Linder, M., Soderlund, H., Teeri, T. T., J. Chromatogr. A 2001, 925, 89; Hofstetter, O., Hofstetter, H., Wilchek, M., Schurig, V., Green, B. Int. J. Bio-Chromatogr. 2000, 5, 165; Hofstetter, O., Hofstetter, H., Schurig, V., Wilchek, M. J. Am. Chem. Soc. 1998, 120, 3251).

This type of molecular species, produced according to a chosen target, can be considered to be a “tailor-made” chiral selector.

However, the development of antibodies specific for an optical isomer requires the production of antibodies in in vivo systems. In addition, small molecules are weakly immunogenic and the relatively large size of antibodies limits the possibility of grafting onto stationary phases (for an HPLC application). The imprinted molecules also have limitations such as their “polyclonal” nature, corresponding to the fact that a great disparity in the enantioselective and nonspecific sites is found at the surface of the polymer. In HPLC, this leads to mediocre efficiency, a considerable trail and a limited enantioselective binding capacity (Sellergren, B. J. Chromatogr. A 2001, 906, 227).

The aim of the present invention is therefore to provide novel chiral stationary phases and novel chiral mobile phases comprising, as chiral selector, oligonucleotides selected by affinity against one of the enantiomers to be separated. These oligonucleotides are capable of specifically recognizing the optical isomer against which they have been selected.

The development of the technique for in vitro amplification and selection by the SELEX technique (Wilson, D. S.; Szostak, J. W. Annu. Rev. Biochem. 1999, 68, 611) has allowed the discovery of aptamers, which are oligonucleotide sequences, capable of complexing a target with very high affinity and specificity. It is thus possible to develop, on demand, oligonucleotides capable of specifically recognizing a given target molecule. Certain aptamers have thus been selected by affinity against the enantiomers of certain molecules. For example, Geiger et al. (Geiger, A.; Burstaller, P.; von der Eltz, H.; Roeder, A.; Famulok, M. Nucleic. Acids Res. 1996, 24, 1029) have selected an aptamer RNA capable of recognizing and enantioselectively distinguishing L-arginine (with a dissociation constant of the order of 300 nM) from D-arginine.

However, aptamer nucleic acids have never yet been used as chiral selectors specific for a pre-designated target enantiomer. Thus, at the current time, only a few examples of analytical tools, based on the aptamer-target molecule reaction, have been described involving, for example, ELISA or electrophoretic techniques (Jayasena, S. D. Clin. Chem. 1999, 45, 1628). Two examples of use, in affinity chromatography, of immobilized aptamers have been published for the purification of proteins (Romig, T. S.; Bell, C.; Drolet, D. W. J. Chromatogr. B 1999, 731, 275) or the separation of adenosine analogues (Deng. Q.; German, I.; Buchanan, D.; Kennedy, R. T. Anal. Chem. 2001, 73, 5415). Aptamer oligonucleotides have never, however, been used in chromatographic or electrophoretic techniques for “tailor-made” chiral separation.

It has now been shown, unexpectedly, that the aptamer nucleic acids selected against one of the enantiomers of a molecule constitute excellent chiral selectors for “tailor-made” chiral separation techniques.

The use of aptamer nucleic acids as chiral selectors offers many advantages. Aptamer oligonucleotides are selected in vitro, are stable in the DNA series (no irreversible denaturation) and can be readily functionalized for immobilization or labeling (grafting of biotin or of fluorescein, for example). In addition, they can be specific for a large variety of targets: macromolecules (lectins, enzymes, antibodies), aminoglycosides, antibiotics, amino acids and peptides.

In addition, it has also been found that the use of aptamer nucleic acids offers the advantage of being able to choose the order of elution of the enantiomers. In fact, according to the principle of inversion of chiral recognition, if an aptamer recognizes one enantiomer of a chiral molecule (E1), then the corresponding mirror image will specifically recognize the other enantiomer (E2). The D-DNA/L-DNA or D/RNA/L-RNA couples will therefore make it possible to choose the order of chromatographic or electrophoretic elution of the enantiomers. This characteristic may be a major advantage in the field of enantioselective purification. In addition, another major advantage of L-RNA lies in the fact that it is barely recognized, or not at all, by degradation enzymes (RNAses).

### DISCLOSURE OF THE INVENTION

The invention relates to the use of nucleic acids as “tailor-made” chiral selectors for the analytical or preparative separation of the optical isomers or enantiomers of a compound.

In a first embodiment, a subject of the invention is a chiral stationary phase for separating enantiomers, comprising an inert solid support to which a chiral selector is bound, in which the chiral selector is an optically active nucleic acid that has an affinity for one of the enantiomers to be separated.

In a second embodiment, a subject of the invention is a chiral mobile phase for separating enantiomers, comprising a liquid migration buffer and a chiral selector in solution in said buffer, in which the chiral selector is an optically active nucleic acid that has an affinity for one of the enantiomers to be separated.

Preferably, the chiral selector is an oligonucleotide comprising from 10 to 60 nucleotides.

In a particular embodiment of the invention, the chiral selector is a deoxyribonucleic acid (DNA). In an advantageous embodiment, the chiral selector is an L-DNA.

In another particular embodiment of the invention, the chiral selector is a ribonucleic acid (RNA).

Preferably, the chiral selector is an RNA comprising modified bases that make said RNA nuclease-resistant. Advantageously, the chiral selector is an L-RNA.

In a particular embodiment of the invention, the chiral selector is the oligonucleotide of SEQ ID No. 1 that has an affinity for D-vasopressin.

In another embodiment of the invention, the chiral selector is the oligonucleotide of SEQ ID No. 2 that has an affinity for L-tyrosinamide.

In another embodiment of the invention, the chiral selector is the oligonucleotide of SEQ ID No. 3 that has an affinity for D-adenosine.

In another embodiment of the invention, the chiral selector is the L-RNA of SEQ ID No. 4 that has an affinity for D-arginine.

In the chiral stationary phases according to the invention, the inert solid support is preferably functionalized with streptavidin, and the chiral selector is preferably a biotinylated nucleic acid. Preferably, the inert solid support consists of polystyrene-divinylbenzene particles functionalized with streptavidin.

The invention also relates to a method of preparing a chiral stationary phase for separating enantiomers, comprising the following steps:

a) an optically active nucleic acid that has an affinity for one of the enantiomers to be separated is selected by in vitro amplification and selection on said enantiomer,

b) the nucleic acid selected in step a) is bound to an inert solid support so as to obtain a chiral stationary phase.

Advantageously, in step a), a D-DNA is selected and, in step b), the L-DNA having the same sequence is bound to an inert solid support so as to obtain a chiral stationary phase.

Advantageously, in step a), a D-RNA is selected and, in step b), the L-RNA having the same sequence is bound to an inert solid support so as to obtain a chiral stationary phase.

Preferably, in step b), the nucleic acid is biotinylated and the inert solid support is functionalized with streptavidin allowing binding of the nucleic acid to the inert solid support.

A subject of the invention is also a method of preparing a chiral mobile phase for separating enantiomers, comprising the following steps:

a) an optically active nucleic acid that has an affinity for one of the enantiomers to be separated is selected by in vitro amplification and selection on said enantiomer,

b) the nucleic acid selected in step a) is dissolved in a liquid migration buffer so as to obtain a chiral mobile phase.

Advantageously, in step a), a D-DNA is selected and, in step b), the L-DNA having the same sequence is dissolved in a liquid migration buffer so as to obtain a chiral mobile phase.

Advantageously, in step a), a D-RNA is selected and, in step b), the L-RNA having the same sequence is dissolved in a liquid migration buffer so as to obtain a chiral mobile phase.

Another subject of the present invention is a method of separating enantiomers that comprises bringing the enantiomers into contact with a chiral stationary phase or a chiral mobile phase comprising a chiral selector and collecting at least one enantiomer, in which the chiral selector is an optically active nucleic acid that has an affinity for one of the enantiomers to be separated.

Preferably, the chiral selector is an oligonucleotide comprising from 10 to 60 nucleotides.

In one embodiment, the chiral selector is a deoxyribonucleic acid (DNA). Advantageously, the chiral selector is an L-DNA.

In another embodiment, the chiral selector is a ribonucleic acid (RNA). Preferably, the chiral selector is an RNA comprising modified bases that makes said RNA nuclease-resistant. More preferably, the chiral selector is an L-RNA.

In one embodiment of the invention, the chiral selector is the oligonucleotide of SEQ ID No. 1 that has an affinity for D-vasopressin.

In another embodiment of the invention, the chiral selector is the oligonucleotide of SEQ ID No. 2 that has an affinity for L-tyrosinamide.

In another embodiment of the invention, the chiral selector is the oligonucleotide of SEQ ID No. 3 that has an affinity for D-adenosine.

In another embodiment of the invention, the chiral selector is the L-RNA of SEQ ID No. 4 that has an affinity for D-arginine.

In the methods using a chiral stationary phase, the inert solid support of the chiral stationary phase is preferably functionalized with streptavidin, and the chiral selector is preferably a biotinylated nucleic acid. Preferably, the inert solid support of the chiral stationary phase consists of polystyrene-divinylbenzene particles functionalized with streptavidin.

Chirality can be defined as a structural characteristic that means that a molecule or a compound is asymmetrical and cannot be superimposed on its mirror image. Molecules exhibiting this characteristic are called optical isomers or enantiomers.

The term “enantiomer” is intended to mean a configurational isomer that can be superimposed on its homolog after symmetry in a mirror. Enantiomers are isomers in which the order of binding of the atoms in the molecule is identical, but in which the spatial distribution is such that they are the mirror image of one another, and cannot therefore be superimposed.

In the present invention, nucleic acids are used as “tailor-made” chiral selectors for separating the optical isomers or enantiomers of a compound.

The nucleic acids or “tailor-made” chiral selectors are selected by affinity against one of the enantiomers to be separated. These nucleic acids are thus capable of specifically retaining or adsorbing one of the enantiomers to be separated.

The term “affinity” is intended to mean the mutual chemical attraction of two substances.

The term “chiral selector” is intended to mean an optically active reagent capable of reacting, of recognizing, of binding or of adsorbing specifically to one of the optical isomers or enantiomers of a compound.

The nucleic acids capable of specifically retaining one of the enantiomers to be separated are selected by in vitro amplification and selection on said enantiomer according to the technique known as the “SELEX” technique.

The “SELEX” technique makes it possible to select nucleic acids, called “aptamers”, that exhibit a high affinity and specificity for a target molecule. When the target molecule is one of the optical isomers of this molecule, the aptamer nucleic acid or the aptamer oligonucleotide obtained by the “SELEX” method is specific for this optical isomer (Geiger, A.; Burgstaller, P.; von der Eltz, H.; Roeder, A.; Famulok, M. Nucleic. Acids Res. 1996, 24, 1029). In addition, it has been shown in the present invention that the specificity and the affinity of these aptamer oligonucleotides is such that they can be used as “tailor-made” chiral selectors for separating the enantiomers of this target molecule.

The “SELEX” in vitro amplification and selection techniques are well known to those skilled in the art (see, for example, Wilson, D. S.; Szostak, J. W. Annu. Rev. Biochem. 1999, 68, 611; WO 99/27133, WO 01/009380, U.S. Pat. No. 5,792,613 and WO 00/056930). Usually, in order to isolate nucleic acids that bind specifically to a chosen target (aptamers), the first step consists in producing, by chemical synthesis, a single-stranded DNA library that serves as basic material for the selection. The molecules in the library contain two fixed regions, hybridation zones for two amplification primers surrounding a “box” of approximately 50 nucleotides randomly inserted. The DNA molecules are transcribed (up to 10¹⁵ molecules) and are subsequently subjected to selection by affinity chromatography. The column chosen is coupled to the target. The molecules bound are subsequently eluted with a mobile phase containing the target, and amplified by PCR. A new DNA library enriched in molecules that specifically complex the target of interest is thus obtained, through several cycles, the representatives of which library are cloned in sequence.

For a given target compound, the “SELEX” methods thus make it possible to select, according to known techniques, aptamer nucleic acids that exhibit a high affinity and specificity for one of the optical isomers of this target compound.

In the present invention, the aptamer nucleic acids are typically used in chromatographic, electrophoretic or electrochromatographic chiral separation techniques. These techniques are well known to those skilled in the art (see, for example, Ceccato A. et al. STP Pharma Pratiques 9(4) 295-310, 1999). Among the existing chromatographic methods, mention will in particular be made of high performance liquid chromatography (HPLC) and thin layer chromatography (TLC). Mention will also be made of HPLC-related electrokinetic techniques (CMEC), such as capillary zone electrophoresis (CZE), micellar electrokinetic chromatography (CMEC) and capillary electrophoresis (ECC).

One of the usual methods consists in passing a solution comprising a mixture of the enantiomers of a compound over a chiral stationary phase or in a chiral mobile phase so as to obtain stronger retention of one of the enantiomers. Careful elution subsequently makes it possible to separately collect the enantiomers of the compound.

The present invention relates to analytical chiral separation but also to preparative chiral separation. Typically, analytical chiral separation makes it possible to determine the enantiomeric purity of a compound, to assay enantiomers or to perform stereoselective pharmacokinetic studies.

The chiral stationary phases, the chiral mobile phases and the methods of the present invention allow the separation of the enantiomers of compounds of all types. Mention will in particular be made of amino acids, nucleosides, oligopeptides, sugars, chemical molecules and in particular medicinal products such as nonsteroidal anti-inflammatories, β-blockers, warfarin or thalidomide. The enantiomers of amino acids, of nucleosides and of oligopeptides are preferably separated.

Although various chiral separation methods exist, they can, however, be subdivided into two major categories: the first concerns the use of chiral stationary phases capable of performing enantiomer separations, and the second consists of the addition of chiral selectors to the mobile phase.

Chiral stationary phases and chiral mobile phases are well known to those skilled in the art and widely described in the literature (J. Chromatogr. A 2001, 906, 1-489).

A subject of the invention is thus a chiral stationary phase for separating the enantiomers or optical isomers of a compound, comprising an inert solid support to which a chiral selector is bound, in which the chiral selector is an optically active nucleic acid that has an affinity for one of the enantiomers to be separated.

The inert solid supports to which the nucleic acid that has an affinity for one of the enantiomers to be separated is bound are known to those skilled in the art. Mention will, for example, be made of agarose particles, silica particles, and polystyrene-divinylbenzene particles.

Advantageously, the inert solid support consists of polystyrene-divinylbenzene particles.

The methods of binding or immobilizing nucleic acids to or on the inert solid support are described in the literature and are well known to those skilled in the art. In fact, nucleic acids are readily functionalized for immobilization on an inert solid support via a biotin-streptavidin bridge or a covalent bond involving a spacer arm.

Advantageously, the inert solid support is functionalized with streptavidin and the nucleic acid is biotinylated for the immobilization of said nucleic acid on the solid support. Particularly advantageously, the inert solid support consists of polystyrene-divinylbenzene particles functionalized with streptavidin.

A subject of the invention is also a chiral mobile phase for separating enantiomers, comprising a liquid migration buffer and a chiral selector in solution in said buffer, in which the chiral selector is an optically active nucleic acid that has an affinity for one of the enantiomers to be separated.

The migration buffers in which the nucleic acid that has an affinity for one of the enantiomers to be separated is dissolved are known to those skilled in the art. Mention will, for example, be made of TRIS, borate, phosphate or acetate buffers.

In the chiral stationary phases and in the chiral mobile phases according to the invention, the chiral selector is a nucleic acid that is obtained by in vitro selection and amplification according to the “SELEX” method on one of the enantiomers to be separated.

According to the present invention, the term “nucleic acid” is intended to mean a single-stranded or double-stranded nucleotide sequence or chain that may be of DNA or RNA type. Preferably, the nucleic acids are single-stranded. The term “nucleic acid” also denotes oligonucleotides and nucleotide chains that have been modified. Typically, the nucleic acids of the present invention can be prepared by conventional molecular biology techniques or by chemical synthesis.

Preferably, the chiral selector is an oligonucleotide comprising 10 to 100 nucleotides, preferably from 10 to 60 nucleotides, and more preferably from 20 to 50 nucleotides.

The chiral selector may be of DNA or RNA type.

In a particularly advantageous embodiment of the invention, the chiral selector is an L-DNA or an L-RNA.

The term “L-DNA” is intended to mean a DNA that has L-deoxyribose units in place of the D-deoxyribose units. DNA naturally comprises D-deoxyribose units (D-DNA).

The term “L-RNA” is intended to mean an RNA that has L-ribose units in place of the D-ribose units. RNA naturally comprises D-ribose units (D-RNA).

The prefix D denotes a dextrorotatory molecule that deflects polarized light to the right.

The prefix L denotes a levorotatory molecule that deflects polarized light to the left.

A D-DNA aptamer and the L-DNA aptamer having the same sequence are therefore the two enantiomers of the same molecule.

Similarly, a D-RNA aptamer and the L-RNA aptamer having the same sequence are therefore the two enantiomers of the same molecule.

According to the principle of the inversion of chiral recognition, if an aptamer recognizes an enantiomer of a chiral molecule (E1), then the corresponding mirror image will specifically recognize the other enantiomer (E2). The D-DNA/L-DNA or D-RNA/L-RNA couples therefore make it possible to choose the order of chromatographic or electrophoretic elution of the enantiomers. The selection of a DNA or of an RNA that has an affinity for the E1 enantiomer of a chiral molecule will automatically make it possible to have the aptamer that will specifically recognize the other enantiomer, E2, by synthesizing the L-DNA having the same sequence or the L-RNA having the same sequence.

In addition, aptamers in the RNA series appear to have greater molecular recognition properties than aptamers in the DNA series. For example, an aptamer in the RNA series capable of discriminating arginine enantiomers with an enantioselectivity of greater than 12 000 has been isolated (Geiger, A.; Burgstaller, P.; von der Eltz, H.; Roeder, A.; Famulok, M. Nucleic. Acids Res. 1996, 24, 1029). Now, the stability of RNA molecules may be limited. This problem can become one of substantial size (role of RNAses in particular).

Consequently, when the chiral selector is of RNA type, it is preferably nuclease-resistant modified RNA. Typically, this RNA comprises modified nucleotides that make it nuclease-resistant. These modified nucleotides comprise, for example, modified bases in which the —OH function in the 2′-position is substituted with an —F or an —NH₂. The “SELEX” methods that make it possible to select nuclease-insensitive RNAs directly by amplification and selection are known to those skilled in the art (Jayasena, S. D. Clin. Chem. 1999, 45, 1628).

Even more advantageously, when the chiral selector is of RNA type, it is an L-RNA. L-RNA molecules have the advantage of not being recognized by degradation enzymes (RNAses).

In one embodiment of the invention, the chiral stationary phase or the chiral mobile phase comprises the oligonucleotide of SEQ ID No. 1. This oligonucleotide was selected by the SELEX method on vasopressin (Williams, K. P.; Liu, X. H.; Schumacher, T. N. M.; Lin, H. Y.; Ausiello, D. A.; Kim, P. S.; Bartel, D. P. Proc. Natl. Acad. Sci. USA 1997, 94, 11285). It has now been shown that this oligonucleotide is capable of retaining D-vasopressin with a high specificity and affinity, thus allowing the separation of the vasopressin enantiomers. The chiral phases of the present invention therefore make it possible, for example, to separate the optical isomers of an oligopeptide.

In another embodiment of the invention, the chiral stationary phase or the chiral mobile phase comprises the oligonucleotide of SEQ ID No. 2. This oligonucleotide was selected by the SELEX method on L-tyrosinamide (Vianini, E. Palumbo, M. Gatto, B. Biorg. Med. Chem. 2001, 9, 2543-2548). It has now been shown that this oligonucleotide is capable of retaining L-tyrosinamide with a high specificity and affinity, thus allowing the separation of the tyrosinamide enantiomers. The chiral phases of the present invention therefore make it possible, for example, to separate the optical isomers of an amino acid derivative.

In another embodiment of the invention, the chiral stationary phase or the chiral mobile phase comprises the oligonucleotide of SEQ ID No. 3. This oligonucleotide was selected by the SELEX method on the D enantiomer of adenosine (Hulzenga, D. E. Szostak, J. W. Biochemistry 1995, 34, 656-665). It has now been shown that this oligonucleotide is capable of retaining D-adenosine with a high specificity and affinity, thus allowing the separation of the adenosine enantiomers. The chiral phases of the present invention therefore make it possible, for example, to separate the optical isomers of a nucleoside.

In another embodiment of the invention, the chiral stationary phase or the chiral mobile phase comprises the L-RNA of SEQ ID No. 4. The D-RNA having the same sequence was selected by the SELEX method on arginine (A. T. Burgstaller, M. Kochoyan, M. Famulok, Nucleic Acids Res. 1995, 23, 4769; P. Chomczynski, Nucleic Acids Res. 1992, 20, 3791). It has now been shown that this D-RNA is capable of retaining L-arginine with a high specificity and affinity, thus allowing the separation of the arginine enantiomers. In addition, the L-RNA having the same sequence is capable of retaining D-arginine with a high specificity and affinity. With this D-RNA/L-RNA couple, the order of elution of the arginine enantiomers can therefore be chosen.

The invention also relates to a method of preparing a chiral stationery phase for separating the enantiomers of a compound or of a molecule, comprising the following steps:

a) an optically active nucleic acid that has an affinity for one of the enantiomers to be separated is selected by in vitro amplification and selection on said enantiomer,

b) the nucleic acid selected in step a) is bound to an inert solid support so as to obtain a chiral stationary phase.

A subject of the invention is also a method of preparing a chiral mobile phase for separating the enantiomers of a compound or of a molecule, comprising the following steps:

a) an optically active nucleic acid that has an affinity for one of the enantiomers to be separated is selected by in vitro amplification and selection on said enantiomer,

b) the nucleic acid selected in step a) is dissolved in a liquid migration buffer so as to obtain a chiral mobile phase.

In step a), a nucleic acid having a high affinity and specificity for one of the optical isomers of the target molecule or compound is selected by the SELEX method. The aptamer nucleic acid thus obtained is subsequently used as a chiral selector for preparing the chiral phases according to usual techniques. The SELEX method allows the selection of D-DNA or D-RNA aptamers. When the intention is to obtain an L-RNA or L-DNA aptamer that specifically recognizes the E1 enantiomer of a chiral molecule, it is sufficient to select the D-DNA or D-RNA aptamer that specifically recognizes the E2 enantiomer of this molecule, and then to synthesize the corresponding L-DNA or L-RNA having the same sequence, which will be specific for the E1 enantiomer. These L-DNA or L-RNA aptamers are subsequently bound to the solid support or dissolved in a migration buffer.

Another subject of the present invention is a method of separating the enantiomers of a compound or of a molecule, that comprises bringing the mixture of enantiomers into contact with a chiral stationary phase or a chiral mobile phase comprising a chiral selector and collecting at least one enantiomer of the mixture, in which the chiral selector is an optically active nucleic acid that has an affinity for one of the enantiomers to be separated.

In a particular embodiment, a solution containing the mixture of enantiomers is brought into contact with the chiral stationary phase in a chromatographic or capillary electrophoresis system. One of the enantiomers is specifically recognized by the chiral selector, which is reflected by a longer retention time. This difference in retention time allows the separate collection of at least one of the enantiomers as it leaves the chromatographic column or electrophoresis capillary.

In another embodiment, the chiral selector is added to the migration buffer in a capillary electrophoresis system, for example. A solution containing the mixture of enantiomers is injected into the capillary in the migration buffer. As above, one of the enantiomers is specifically recognized by the chiral selector, which is reflected by a longer migration time in the capillary. This difference in retention time allows the separate collection of at least one of the enantiomers as it leaves the capillary.

In the analytical separation methods, the enantiomers thus separated and then collected are subsequently quantified or assayed in a precise manner according to usual techniques.

Another subject of the present invention is a method of separating vasopressin enantiomers, that comprises bringing a mixture of vasopressin enantiomers into contact with a chiral stationary phase or a chiral mobile phase comprising a chiral selector and collecting at least one enantiomer, in which the chiral selector is the oligonucleotide of SEQ ID No. 1 that has an affinity for D-vasopressin.

Another subject of the present invention is a method of separating tyrosinamide enantiomers, that comprises bringing a mixture of tyrosinamide enantiomers into contact with a chiral stationary phase or a chiral mobile phase comprising a chiral selector and collecting at least one tyrosinamide enantiomer, in which the chiral selector is the oligonucleotide of SEQ ID No. 2 that has an affinity for L-tyrosinamide.

Another subject of the present invention is a method of separating adenosine enantiomers, that comprises bringing a mixture of adenosine enantiomers into contact with a chiral stationary phase or a chiral mobile phase comprising a chiral selector and collecting at least one adenosine enantiomer, in which the chiral selector is the oligonucleotide of SEQ ID No. 3 that has an affinity for D-adenosine.

Another subject of the present invention is a method of separating arginine enantiomers, that comprises bringing a mixture of arginine enantiomers into contact with a chiral stationary phase or a chiral mobile phase comprising a chiral selector and collecting at least one arginine enantiomer, in which the chiral selector is the L-RNA of SEQ ID No. 4 that has an affinity for D-arginine.

The examples and figures below will make it possible to demonstrate certain advantages and characteristics of the present invention.

### FIGURES

FIG. 1: Sequence and secondary structure of the aptamer specifically selected against D-vasopressin. L₁ is the loop for specific binding of the D-enantiomer.

FIG. 2: Separation of the vasopressin enantiomers (L: L-enantiomer and D: D-enantiomer) on the aptamer stationary phase. Column: 2.1×30 mm. Temperature: 20° C. Mobile phase composition: 5 mM phosphate buffer, 100 mM KCl, 3 mM MgCl₂, pH 7.0. Flow rate: 150 μl/min. Injection: 100 nl (concentration 0.9 mM). UV detection at 195 nm.

FIG. 3: Lnk as a function of the pH of the mobile phase for the D-peptide (k_{D}). Column: 2.1×30 mm. Temperature: 20° C. Mobile phase composition: 5 mM phosphate buffer, 100 mM KCl, 3 mM MgCl₂. Flow rate: 150 μl/min. Injection: 100 nl (concentration 0.9 mM). UV detection at 195 nm.

FIG. 4: Lnk as a function of lncₓ (cₓ: concentration of KCl of the mobile phase 25-100 mM) for the D-peptide (k_{D}). Column: 2.1×30 mm. Temperature: 20° C. Mobile phase composition: 5 mM phosphate buffer, 100 mM KCl, 3 mM MgCl₂, pH 6.0. Flow rate: 150 μl/min. Injection: 100 nl (concentration 0.9 mM). UV detection at 195 nm.

FIG. 5: Lnk as a function of 1/T (T column temperature, 273-298K) for the D-peptide (k_{D}). Column: 2.1×30 mm. Mobile phase composition: 5 mM phosphate buffer, 100 mM KCl, 3 mM MgCl₂, pH 6.0. Flow rate: 150 μl/min. Injection: 100 nl (concentration 0.9 mM). UV detection at 195 nm.

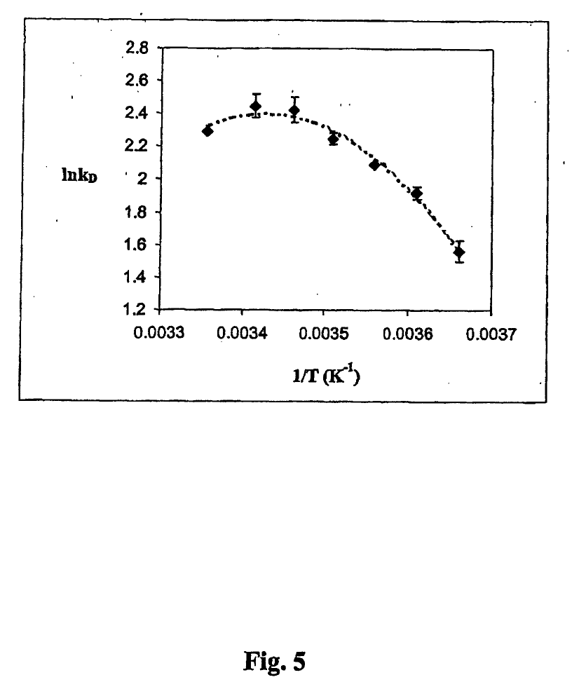

FIG. 6: Separation of the vasopressin enantiomers (L: L-enantiomer and D: D-enantiomer) on the aptamer stationary phase. Column: 2.1×30 mm. Temperature: 20° C. Mobile phase composition: 5 mM phosphate buffer, 3 mM MgCl₂, pH 7.0. Flow rate: 150 μl/min. Injection: 100 nl (concentration 0.9 mM). UV detection at 195 nm.

FIG. 7: Sequence of the DNA series aptamers selected against D-adenosine (ADE) and L-tyrosinamide (TYR).

FIG. 8: Separation of the adenosine enantiomers (L: L-enantiomer and D: D-enantiomer) on the adenosine aptamer stationary phase. Column: 0.75=370 mm. Temperature: 24° C. Mobile phase composition: 20 mM phosphate buffer, 25 mM KCl, 1.5 mM MgCl₂ adjusted to pH 6. Flow rate: 50 μl/min. Injection: 100 nl (amount injected 70 pmol). UV detection at 260 nm.

FIG. 9: Separation of the tyrosinamide enantiomers (L: L-enantiomer and D: D-enantiomer) on the aptamer stationary phase. Column: 0.75×250 mm. Temperature: 26° C. Mobile phase composition: phosphate buffer: 20 mM, 25 mM KCl, 1.5 mM MgCl₂ adjusted to pH 6. Flow rate: 20 μl/min. Injection: 100 nl (amount injected 70 pmol). UV detection at 224 nm.

FIG. 10: Sequence and secondary structure of the enantioselective RNA aptamer used for separating the L- and D-enantiomers of arginine.

FIG. 11: Separation of the arginine enantiomers (L: L-enantiomer and D: D-enantiomer) on the D-RNA aptamer stationary phase 1. Column: 0.75×370 mm. Temperature: 4° C. Mobile phase composition: phosphate buffer: 25 mM, 25 mM NaCl, 5 mM MgCl₂ adjusted to pH 7.3. Flow rate: 50 μl/min. Injection: 100 nl (amount injected 50 ng). UV detection at 208 nm.

FIG. 12: Ratio of the retention factor of the target enantiomer at day D (k) to the retention factor of the target enantiomer at day 0 (day of production) (k₀) as a function of the time of use for the various columns evaluated.

FIG. 13: Separation of the arginine enantiomers (L: L-enantiomer and D: D-enantiomer) on the L-RNA aptamer stationary phase 5. Column: 0.75×370 mm. Temperature: 4° C. Mobile phase composition: phosphate buffer: 25 mM, 25 mM NaCl, 5 mM MgCl₂ adjusted to pH 7.3. Flow rate: 50 μl/min. Injection: 100 nl (amount injected 50 ng). UV detection at 208 nm.

### EXAMPLES

### Example 1

### Chromatographic Separation of Vasopressin Enantiomers

A DNA-series aptamer (biotinylated in the 5′ position) characterized by its enantioselectivity toward an oligopeptide, D-vasopressin, was immobilized on a chromatographic support containing streptavidin grafts. The stationary phase thus created was used for the purposes of chromatographic separation of vasopressin enantiomers.

1. Materials and Methods

1.1. Reagents and Materials

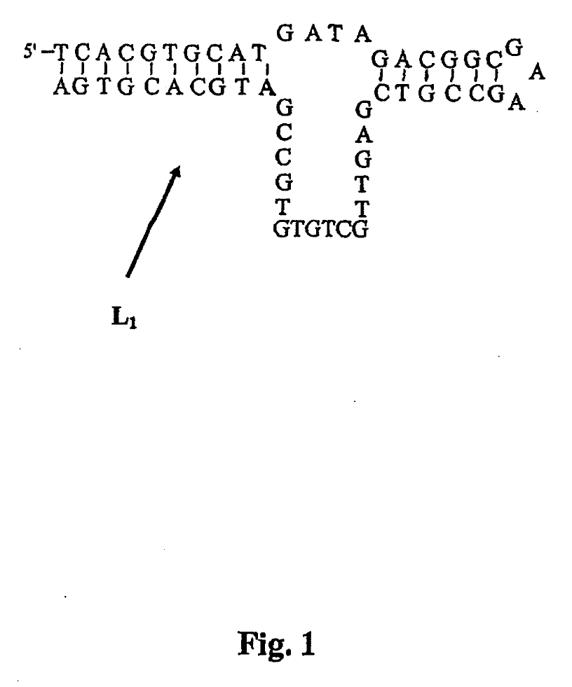

The L series vasopressin (CYFQNCPRG-NH₂) was provided by the company Sigma (Saint-Quentin, France). The D series vasopressin was synthesized by the company Millegen (Toulouse, France) from D series amino acids, and purified by reverse-phase polarity HPLC. The identity of the peptide was confirmed by mass spectrometry. Na₂HPO₄, NaH₂PO₄, KCl and MgCl₂ were provided by Prolabo (Paris, France). The HPLC water was obtained by means of the Elgastate purification system (Odil, Talant, France). The 55-base DNA-series single-stranded oligonucleotide (FIG. 1) was synthesized and purified by gel electrophoresis (Eurogentec, Herstal, Belgium).

The chromatographic column containing streptavidin grafts (BA POROS: 2.1×30 mm) packed with 20 μm stationary phase particles and the binding buffer (10 mM phosphate, 150 mM NaCl, pH=7.2) were provided by the company Applied Biosystems (Courtaboeuf, France).

1.2. Preparation of the Stationary Phase

Before immobilization on the chromatographic support, the aptamer was treated by heating at 70° C. for 5 min (phosphate buffer: 20 mM, 25 mM KCl, 1.5 mM MgCl₂ adjusted to pH 7.6) and cooling to ambient temperature for 30 minutes. The POROS column was equilibrated by passing approximately ˜20 ml of binding buffer through the chromatographic system. 29 nmol of biotinylated aptamer were applied to the chromatographic column using a pump fixed at a flow rate of 100 μl/min for 3 hours and at ambient temperature. ˜10 ml of binding buffer were subsequently passed through the column in order to elute the unbound oligonucleotide fraction. The amount of oligonucleotide bound to the chromatographic support was quantified from the absorbance at 280 nm of the starting fraction and of the unbound DNA fraction. After each use, the column was conserved at +4° C. in the binding buffer.

1.3. Equipment

The HPLC system comprised a Shimadzu 10AT pump (Sarreguemines, France), a Shimadzu SIL-10AD auto-injection system, a Shimadzu SPD-10A UV-visible detector (λ=195 nm), and a Shimadzu SCL-10A control system coupled to Class VP data analysis software (Shimadzu).

1.4. Chromatographic Conditions

The mobile phase consisted of 5 mM phosphate buffer and 3 mM MgCl₂. In the context of the studies on the influence of the parameters of the medium on the retention of the compounds, the pH of the mobile phase ranged from 5 to 8, the column temperature from 0 to 25° C. and the KCl concentration from 25 mM to 100 mM. The flow rate of the mobile phase was 150 μl/min and the amount of peptide injected was 0.9 nmol. The solutes were injected, for each condition, at least three times.

1.5. Determination of the Chromatographic Parameters

The affinity to solutes of the stationary phase was determined by calculating the retention factor k

$$k = \frac{{t}_{R} - {t}_{0}}{{t}_{0}} \qquad ( 1 )$$

t_{R} is the retention time of the solute and t₀ is the retention time zero. t_{R} was determined from the 1st moment of the peak. t₀ was determined from the peak of the mobile phase.

The effectiveness of the column was evaluated by calculating the number of theoretical plateaus h

$$\begin{matrix}h = \frac{L}{{d}_{p} N} & ( 2 ) \\ with N = 5.54 {( \frac{{t}_{R}}{δ} )}^{2} & ( 3 )\end{matrix}$$

N is the number of theoretical plateaus, δ is the width of the peak at mid-height, L is the length of the column and dₚ is the diameter of the POROS particles.

The asymmetry factor Aₛ was calculated at 10% of the height of the peak.

2. Results

2.1. Demonstration of the Enantioselectivity of the Aptamer Column

21 nmol of aptamer were immobilized in the 100 μl column. The maximum binding capacity of the POROS chromatographic support is 12.5 nmol/100 μl for a biotinylated antibody. This result indicates that the oligonucleotide can bind to a greater extent, probably because the steric hindrance is lower. Similar conclusions have been reported by Deng et al. (Deng, Q.; German, I.; Buchanan, D.; Kennedy, R. T. Anal. Chem. 2001, 73, 5415).

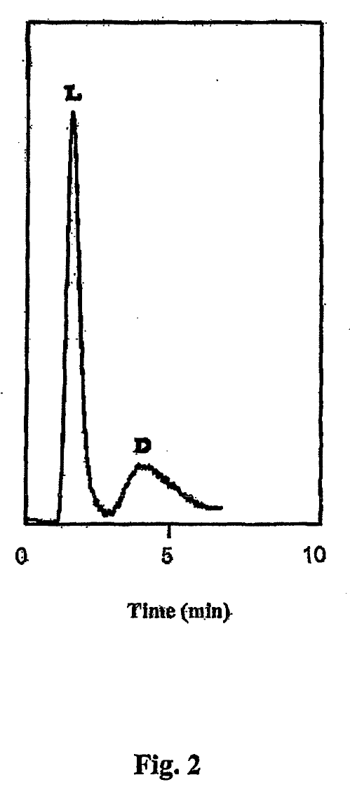

An enantiomer mixture was injected under conditions similar to those used for selecting the aptamer (5 mM phosphate buffer, 100 mM KCl, 3.0 mM MgCl₂, pH 7.0, column temperature 20° C.). Under these conditions, the D-peptide is retained by the column, whereas the L-peptide is eluted in the dead volume (FIG. 2).

2.2. Determination of the Optimal Conditions for Binding and for Separation

To define the optimal conditions for separation, the influence of the pH and of the ionic strength of the mobile phase and of the column temperature on the retention of the solutes was studied.

Influence of the pH of the Mobile Phase on k

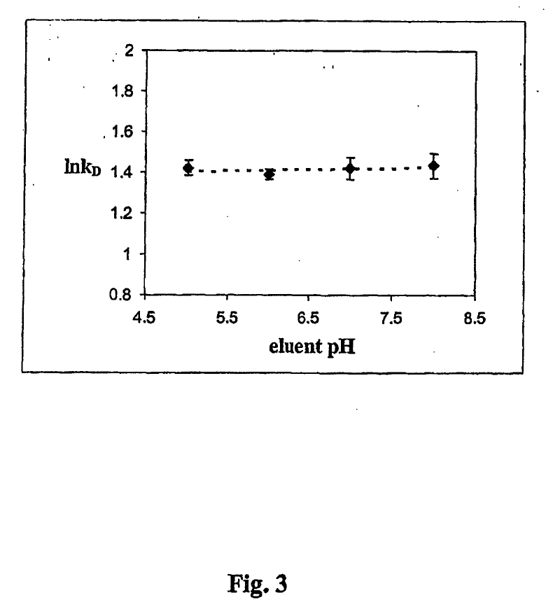

The analysis of the effects of the pH on the retention of the solutes was carried out between pH 5.0 and 8.0. The mobile phase consisted of 5 mM phosphate buffer, 100 mM KCl, 3.0 mM MgCl₂, for a column temperature of 20° C. The L enantiomer is eluted in the dead volume whatever the pH of the mobile phase. For the D enantiomer, the pH of the mobile phase has no influence on the retention (FIG. 3).

Influence of the ionic Strength of the Mobile Phase on k

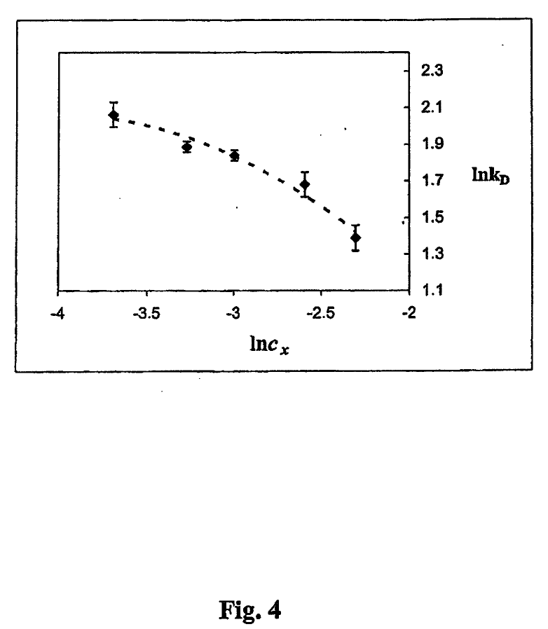

The analysis of the effects of the ionic strength of the mobile phase on the retention of the solutes was carried out in a KCl concentration range of from 25 mM to 100 mM for a column temperature of 20° C. The mobile phase consisted of 5 mM phosphate buffer, 3 mM MgCl₂, pH 6.0. The L enantiomer is eluted in the dead volume whatever the ionic strength of the mobile phase. For its part, the affinity of the D enantiomer decreases with the increase in salt concentration (FIG. 4). This demonstrates that coulombic interactions are involved in the binding of the D-vasopressin to the aptamer phase.

Influence of Column Temperature on k

The analysis of the effects of the column temperature on the retention of the solutes was carried out in a range of from 0 to 25° C. The mobile phase consisted of 5 mM phosphate buffer, 3 mM MgCl₂, pH 6.0. The affinity of the D-enantiomer for the stationary phase goes through a maximum at around 20° C. (phenomenon driven entropically at low temperatures and enthalpically at 25° C.) whereas the L-enantiomer is always eluted in the dead volume.

2.3. Chromatographic Properties of the Column Enantioselectivity and Analysis Time

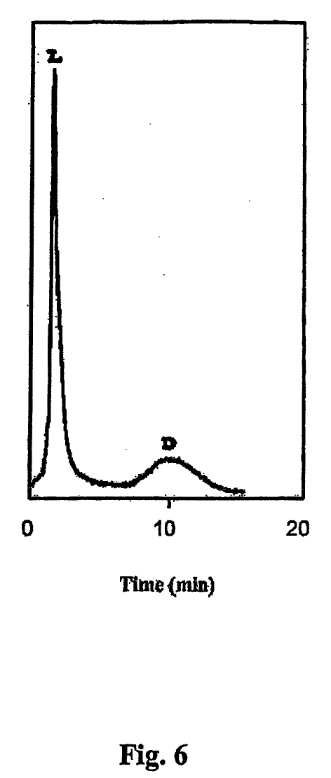

The major advantage of the chiral aptamer column is that the enantioselectivity is virtually infinite since the L enantiomer does not interact with the stationary phase. In this sense, this chiral selector appears to be just as discriminating as the antibodies (Hofstetter, O.; Lindstrom, H.; Hofstetter, H. Anal. Chem. 2002, 74, 2119) and superior to the imprinted molecules (Sellergren, B. J. Chromatogr. A 2001, 906, 227). It is important to note here that the procedure for binding the aptamer to the POROS support does not significantly impair its stereoselective capacities and is found to be adequate for use in HPLC. The separation of the vasopressin enantiomers and the analysis time can be readily modulated by modifying the ionic strength of the medium and the column temperature. The peptide enantiomers cannot be completely resolved at high ionic strength and at low temperature. However, separation with a return to the baseline in 7 minutes was obtained at ambient temperature with 100 mM of KCl in the mobile phase (FIG. 2) or at lower temperature without KCl in the eluent. At ambient temperature, a considerable increase in enantioselectivity associated with an increase in analysis time (15 minutes) was observed at low ionic strength (FIG. 6).

Peak Broadening and Asymmetry

The height equivalent to a theoretical plateau h for the D enantiomer is between 35 and 40 with an asymmetry factor ˜1.5 (ideal Aₛ=1). By way of comparison, h for L-phenylalanine anilide on an imprinted stationary phase ranged between 35 and 150 according to the flow rate of the mobile phase (Sellergren, B. Shea, K. J. J. Chromatogr. A 1995, 690, 29). On an antibody stationary phase, the values of h observed for various amino acids were between 20 and 200 (Hofstetter, O.; Lindstrom, H.; Hofstetter, H. Anal. Chem. 2002, 74, 2119). These results prove that the effectiveness of the aptamer column is similar to those obtained for the “tailor-made” chiral stationary phases.

Column Stability Over Time

The column stability was evaluated by comparing the retention factor of the D enantiomer before and after 5 months of use under the same conditions. No significant difference was observed, demonstrating that the aptamer column is stable over time.

An oligonucleotide specifically designed against a target enantiomer can therefore be used as a novel “tailor-made” chiral selector in HPLC. The simple conditions for use, the virtually infinite enantio-selectivity, the correct efficiency and the very good stability obtained with these aptamers make them a very good tool for industrial application for the development of novel chiral stationary phases selected against target enantiomers of molecules of biological or medicinal interest. This novel type of chiral selector can also be used in other analytical methodologies.

### Example 2

### Use in Capillary Electrophoresis

The enantioselective properties of the aptamers can also be used in chiral capillary electrophoresis. Two possibilities are available to us:

Case 1: the aptamer is dissolved in the migration buffer at a concentration of the order of one millimolar,

Case 2: the aptamer is immobilized on a silica-type chromatographic support. In this case, the procedure will be carried out by electrochromatography.

1. Use of the Aptamer in the Liquid Phase

1.1. Equipment

A capillary electrophoresis system comprising a capillary made of molten silica with an internal diameter of around 50 μm and a length of 40 cm, a power supply, an injection device and a fluorimetric detector (or a mass spectrometer) can be used.

1.2. Operating Conditions

A migration buffer of the type 50 mM phosphate buffer, pH 7.0, containing 3 mM MgCl₂ can be used. The aptamer of interest is dissolved in this buffer at a concentration of the order of one micromolar or one millimolar. The voltage applied between the two electrodes is of the order of 20 kV. The migration takes place from the anode to the cathode in the presence of an electroosmotic flow.

1.3. Results

With no aptamers in the migration buffer, the two enantiomers migrate in the electrophoretic system at the same speed according to their mass/charge ratio. In the presence of aptamers, the selective complexation of the target enantiomer by the oligonucleotide makes it possible to separate the two optical isomers. This is because the target enantiomer migrates much more slowly, while the other enantiomer (not complexed) still has the same migration speed.

Because of the addition of the oligonucleotide (which absorbs in the UV range) to the medium, it is necessary for the target molecules to be fluorescent or for a more improved detection system of the mass spectrometry type to be used.

2. Immobilization of the Aptamer on a Silica-Type Chromatographic Support

2.1. Equipment

A capillary electrophoresis system comprising a capillary made of molten silica with an internal diameter of around 50 μm and a length of 40 cm, a power supply, an injection device and a UV detector can, for example, be used.

2.2. Operating Conditions

The migration buffer of the type 50 mM phosphate buffer, pH 7.0, containing 3 mM MgCl₂ can be used. The biotinylated aptamer (cf. materials and methods described above) is immobilized on a chromatographic support of the type such as silica particles functionalized with streptavidin. The molten silica capillary is packed with stationary phase particles using the Applied Biosystems (Courtaboeuf, France) capillary packing device and an HPLC pump. The voltage applied between the two electrodes is of the order of 20 kV. The migration takes place from the anode to the cathode under the action of the electroosmotic flow created.

2.3. Results

Only the affinity of the enantiomers for the immobilized aptamer plays a role in the separation, as in conventional chromatography. The target enantiomer therefore migrates much more slowly than the other optical isomer, with an enantioselectivity equivalent to that found in the chromatographic system described above. An improvement in the efficiency of the separation is expected due to the absence of a parabolic flow (such as that found in chromatography).

### Example 3

### Use of Nuclease-Resistant RNA as Aptamers

The RNA-series aptamers appear to have a more marked capacity for interacting with a predesignated target (in particular for small molecules) than the DNA-series aptamers. However, RNA is very sensitive to RNases in the environment and therefore degrades rapidly. However, at the current time, SELEX selection procedures established using modified bases, for example by substituting the —OH function in the 2′-position with an —F or an —NH₂, exist (Jayasena, S. D. Clin. Chem. 1999, 45, 1628). This type of modified SELEX can be exploited for selecting a nuclease-insensitive RNA aptamer specific for a target enantiomer. The procedure used for the chiral separation is in all respects identical to that which has just been described in detail above.

Ultimately, based on effective in vitro selection studies directed toward optimal selection of enantioselective aptamers, a library of sequences specific for numerous enantiomer couples can be set up.

### Example 4

### Separation of Adenosine Enantiomers and Tyrosinamide Enantiomers by High Performance Microchromatography

Two DNA-series aptamers (biotinylated in the 5′-position) characterized by their affinity for D-adenosine (Huizenga, D. E. Szostak, J. W. Biochemistry 1995, 34, 656-665) and L-tyrosinamide (Vianini, E. Palumbo, M. Gatto, B. Biorg. Med. Chem. 2001, 9, 2543-2548) were immobilized on a chromatographic support containing streptavidin grafts. The stationary phases thus created were used for the purposes of chromatographic separation of the enantiomers of these two molecules by micro-HPLC.

1. Materials and Methods

1.1. Reagents and Materials

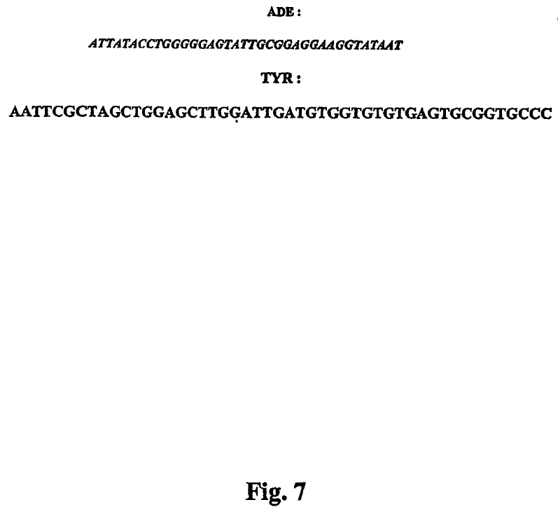

The D-adenosine and the L-tyrosinamide were provided by the company Sigma (Saint-Quentin, France). The D-tyrosinamide was synthesized by the company Millegen (Toulouse, France) and purified by reverse-phase polarity HPLC. The identity of the peptide was confirmed by mass spectrometry. The L-adenosine was provided by the company Chemgenes (Ashland, USA). Na₂HPO₄, NaH₂PO₄, KCl and MgCl₂ were provided by Prolabo (Paris, France). The HPLC water was obtained using the Elgastat purification system (Odil, Talant, France). The DNA-series single-stranded oligonucleotides (FIG. 7) were synthesized and purified by gel electrophoresis (Eurogentec, Herstal, Belgium).

1.2. Preparation of the Stationary Phase and of the Chromatographic Microcolumns

Before immobilization on the chromatographic support, the aptamers were treated by heating at 70° C. for 5 min (phosphate buffer: 20 mM, 25 mM KCl, 1.5 mM MgCl₂ adjusted to pH 6) and cooling to ambient temperature for 30 minutes. 1000 μl (for the adenosine) or 500 μl (for the tyrosinamide) of a suspension of streptavidin POROS particles (20 μm) provided by the company Applied Biosystems (Courtaboeuf, France) were brought into contact for 3 hours, with agitation at ambient temperature, with 400 μl of adenosine aptamer at a concentration of 79 nmol/ml or with 130 μl of tyrosinamide aptamer at a concentration of 76 nmol/ml. The POROS particles thus modified (aptamers bound to the support) were used to pack the chromatographic microcolumns 0.75×370 mm (for the adenosine) and 0.75×250 mm (for the tyrosinamide) in size. A high pressure packing device, provided by the company Applied Biosystems (Courteboeuf, France), was used. After each use, the columns were conserved at +4° C. in the phosphate buffer: 20 mM, 25 mM KCl; 1.5 mM MgCl₂ adjusted to pH 6.

1.3. Equipment

The HPLC system comprised a Shimadzu 10AT pump (Sarreguemines, France), a Shimadzu SIL-10AD auto-injection system, a Shimadzu SPD-10A UV visible detector with a 2 μl semi-micro cell (λ=224 for tyrosinamide or 260 nm for adenosine), and a Shimadzu SCL-10A control system coupled to Class-VP data analysis software (Shimadzu).

1.4. Chromatographic Conditions

The mobile phase consisted of phosphate buffer: 20 mM, 25 mM KCl, 1.5 mM MgCl₂ adjusted to pH 6. The flow rate of the mobile phase was 50 μl/min (for adenosine) or 20 μl/min (for tyrosinamide). The amount of solute injected was 70 pmol for the adenosine enantiomers and the tyrosinamide enantiomers. The solutes were injected at least three times.

1.5. Determination of the Chromatographic Parameters

The affinity of the solutes for the stationary phase was determined by calculating the retention factor k

$$k = \frac{{t}_{R} - {t}_{0}}{{t}_{0}} \qquad ( 1 )$$

t_{R} is the retention time of the solute and t₀ is the retention time zero. t_{R} was determined from the 1st moment of the peak. t₀ was determined from the peak of the mobile phase.

The apparent enantioselectivity α was calculated in the following way

$$α = \frac{{k}_{2}}{{k}_{1}} \qquad ( 2 )$$

k₂ and k₁ represent respectively, the retention factors of enantiomers that are the most retained and the least retained.

2. Results

2.1. Resolution of the Adenosine Enantiomers and of the Tyrosinamide Enantiomers by Means of the Two Microcolumns

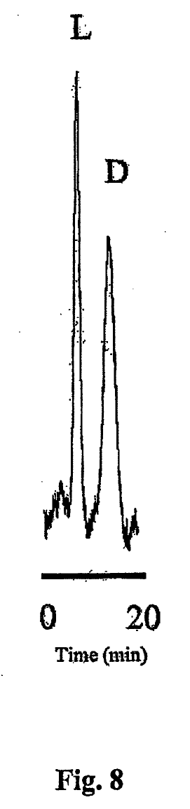

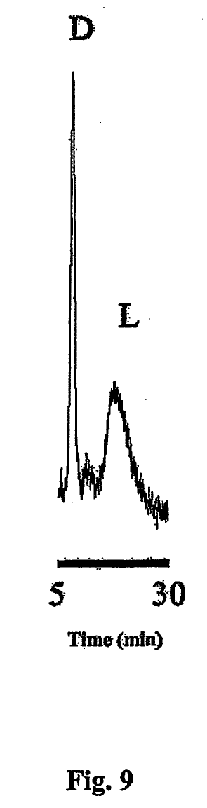

An enantiomer mixture was injected into the two columns at a temperature of 24° C. for the separation of the adenosine enantiomers and 26° C. for the separation of the tyrosinamide enantiomers. In the two cases, the enantiomers were easily separated with a return to the baseline (FIGS. 8 and 9). The enantiomers which were the most retained by the chromatographic columns corresponded to those that had been used to select the aptamer, i.e. the D-adenosine and the L-tyrosinamide.

2.2. Enantioselectivity

The enantioselectivity obtained with the adenosine aptamer column was of the order of 3.4. In the case of tyrosinamide, a was equal to 34, one of the greatest enantioselectivities ever reported for small molecules.

We were able to extend the application of oligonucleotides specifically designated against a target enantiomer to the chiral separation of small molecules (nucleoside and amino acid derivative) by micro-HPLC. This result demonstrates that this novel type of “tailor-made” chiral selector can be used in a very broad range of biological or medicinal applications.

### Example 5

### D-RNA-Series and L-RNA-Series Aptamers as Novel Specific Chiral Stationary Phases

1. Materials and Methods

1.1 Reagents and Materials

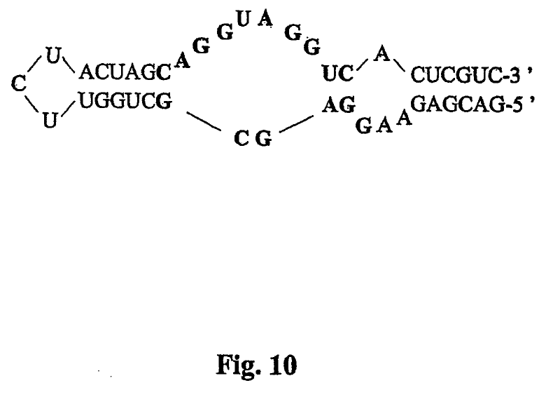

The L and D enantiomers of arginine are provided by the company Sigma (Saint-Quentin, France). Na₂HPO₄, NaH₂PO₄, NaCl and MgCl₂ are provided by Prolabo (Paris, France). The RNase inhibitor ProtectRNA® is provided by Sigma Aldrich. The HPLC water is obtained by means of the Elgastat purification system (Odil, Talant, France). The 44-base D-RNA-series or L-RNA-series single-stranded oligonucleotides (FIG. 10) are synthesized by Eurogentec (Herstal, Belgium) or CureVac (Tubingen, Germany) and purified by gel electrophoresis or HPLC.

1.2 Preparation of the Stationary Phase and of the Chromatographic Microcolumns

Before immobilization on the chromatographic support, the aptamers were treated by heating at 85° C. for 5 min (phosphate buffer: 25 mM, 25 mM NaCl, 5 mM MgCl₂ adjusted to pH 7.3) and cooling to ambient temperature for 30 minutes. 1000 μl of a suspension of streptavidin POROS particles (20 μm) provided by the company Applied Biosystems (Courtaboeuf, France) were brought into contact for 3 hours, with agitation at ambient temperature, with 60 nmol of aptamers. The POROS particles thus modified (aptamers bound to the support) were used to pack the chromatographic microcolumns 0.75×370 mm (stationary phases 1, 4, 5) or 0.51×340 mm (stationary phases 2, 3) in size. A high pressure packing device, provided by the company Applied Biosystems (Courtaboeuf, France), was used.

1.3 Storage Conditions and Stability Study

After each use, columns 1, 2, 4 and 5 were conserved in the phosphate buffer: 25 mM, 25 mM NaCl, 5 mM MgCl₂ adjusted to pH 7.3. On the other hand, column 3 was stored in the buffer containing the RNase inhibitor (2 ml per 1000 ml of mobile phase). All the columns were conserved at 4° C. after each use. Before each experiment, column 3 was rinsed with the mobile phase so as to remove the RNase inhibitor. For an accurate comparison of the stability of the stationary phases, columns 2 and 3 were produced from the same sample of D-RNA (Eurogentec). Columns 4 and 5 were produced from D-RNA or from L-RNA originating from the same supply (CureVac). Columns 2, 3, 4 and 5 were used under identical operating conditions: same mobile phase, same experiment time and, column temperature equal to 4° C.

1.4 Equipment

The HPLC system comprised a Shimadzu 10AT pump (Sarreguemines, France), a Rheodyne injection valve model 7125 (Interchim, Montlucon, France), a Shimadzu SPD-10A UV-visible detector (λ=208 nm), and a Shimadzu SCL-10A control system coupled to Class-VP data analysis software (Shimadzu).

1.5 Chromatographic Conditions

The mobile phase consisted of phosphate buffer: 25 mM, 25 mM NaCl, 5 mM MgCl₂ adjusted to pH 7.3. The flow rate of the mobile phase was 50 μl/min (for stationary phases 1, 4, 5) or 25 μl/min (for stationary phases 2, 3). The concentration of solute injected ranged from 50 to 500 μg/ml. The solutes were injected (100 ml) at least three times.

1.6 Determination of the Chromatographic Parameters

The retention factor k was determined as follows:

$$k = \frac{{t}_{R} - {t}_{0}}{{t}_{0}} \qquad ( 1 )$$

t_{R} is the retention time of the solute and t₀ is the retention time zero. t_{R} was determined from the maximum of the peak. t₀ was determined from the sodium nitrate peak.

1.7 Study of the Degradation of the RNA Stationary Phases

The retention factor is conventionally given by:
k=m_{L}K/V_{M} (2)

m_{L} is the number of active sites in the column, V_{M} is the dead volume and K is the solute-stationary phase association constant. Therefore, for a given chromatographic system, a variation in the retention factor under identical conditions reflects a change in the number of active sites within the column. The kinetics of degradation of the RNA was therefore studied indirectly by examining the modification of the retention factor as a function of time. The retention data were adjusted with the following equation:
Ink=−St+A (3)

S is the apparent retention time decrease constant, t is the time and A is an adjustment parameter.

2. Results

2.1 Separation of the Arginine Enantiomers by Means of the D-RNA Stationary Phase 1 and Stability Study

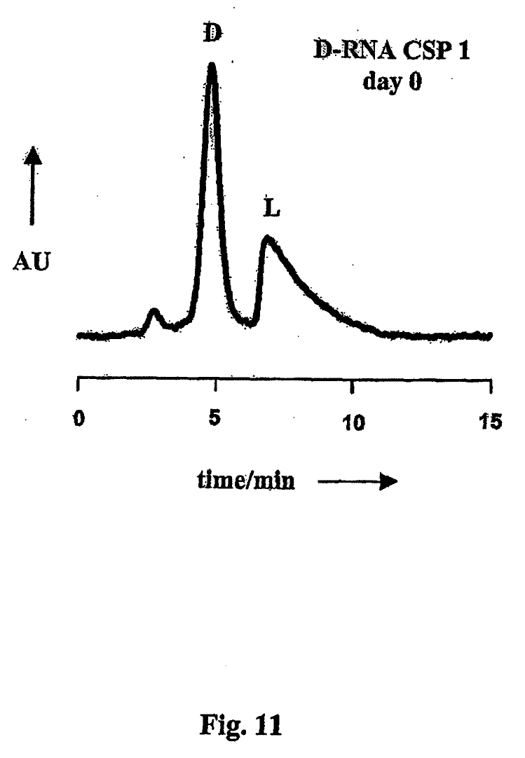

A mixture of arginine enantiomers was injected into the D-RNA column 1 at temperatures ranging from 4° C. to 17° C. The enantiomers were separated with a return to baseline (FIG. 11). The enantiomer that was the most retained by the chromatographic column corresponded to that which had been used to select the aptamer, i.e. the L enantiomer.

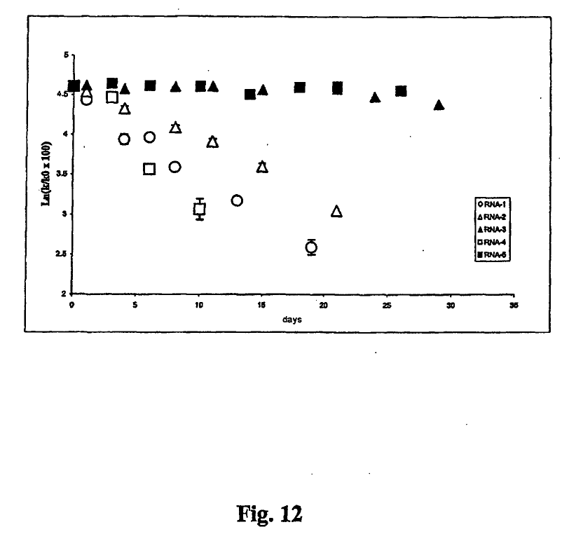

The stability of the D-RNA CSP stationary phase 1 was evaluated by comparing the retention time of the target enantiomer for several weeks. The ratio of the retention factor at day D (k) to the retention factor at day 0 (day of production) (k₀) was plotted as a function of time (FIG. 12).

The performance levels of the D-RNA stationary phase 1 decreased very greatly as shown by the constant S (Table 1). A complete loss of resolution was observed after 19 days of use.

TABLE 1
RNA stationary phase degradation

| Stationary | Chiral | | |
|---|---|---|---|
| phase | configuration | Storage | S(10⁻³ h⁻¹) |
| 1, 2, 4 | D | phosphate buffer | 4.3, 3.0, 7.0 |
| 3 | D | RNase inhibitor | 0.3 |
| 5 | L | phosphate buffer | <0.1^{a} |

^{a} No significant variation in the retention factor of the target enantiomer after 26 days of use.

These results demonstrate that the number of active sites of the column decreases dramatically with time. Since our work was not carried out in an “RNase-free” environment, which is incompatible with a re-usable RNA stationary phase, it is probable that contamination of our system with RNases occurred (P. Chomczynski, Nucleic Acids Res. 1992, 20, 3791), allowing cleavage of the phosphodiester bonds of the RNA (B. N. Trawick, A. T. Daniher, J. K. Bashkin, Chem. Rev. 1998, 98, 939; Y. Li, R. R. Breaker, J. Am. Chem. Soc. 1999, 121, 5364. c) U. Kaukinen, S. Lyytikainen, S. Mikkola, H. Lonnberg, Nucleic Acids Res. 2002, 30, 468).

2.2 Role of RNases in the Degradation of the D-RNA (D-RNA Stationary Phases 2 and 3)

In order to test this hypothesis, two other columns (RNA 2 and 3) were produced and their stability was examined. D-RNA column 2 was stored in the mobile phase, while RNA column 3 was conditioned with an RNase inhibitor. The D-RNA stationary phase 3 is 10 times more stable than the D-RNA stationary phase 2 (Table 1 and FIG. 12), confirming that RNases play a major role in degradation of the D-RNA columns.

2.3 Stability of the L-RNA Stationary Phase 5

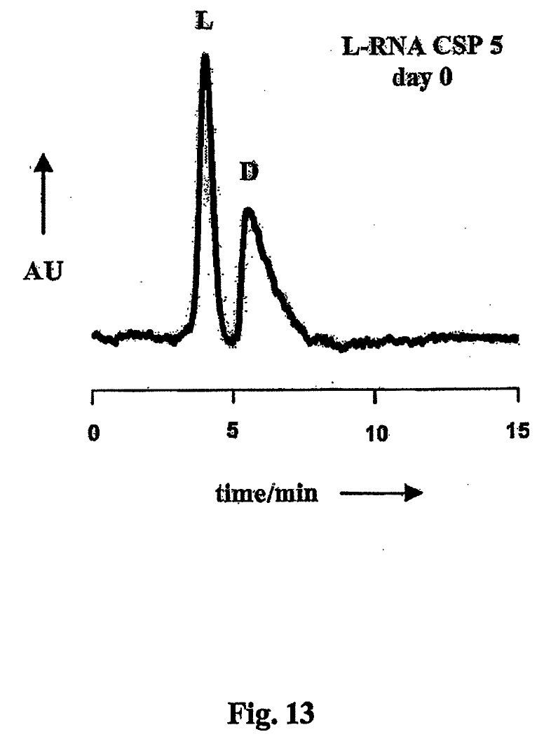

In order to solve this stability problem, the “mirror image” approach was tested. Two columns, D-RNA 4 and L-RNA 5 were produced and evaluated for several weeks. First of all, according to the principles of stereochemistry, the D enantiomer of arginine is preferentially recognized by the mirror image of the natural RNA, the L-RNA. This is responsible for an inversion in the order of elution on the column L-RNA 5 (FIG. 13).

In addition, the column L-RNA 5 is found to be very stable over time since no significant variation in the retention factor of the target enantiomer was observed after 26 days of use (FIG. 12 and Table 1).

We have demonstrated that the “mirror image” approach is a very effective strategy for rendering RNA-series aptamer chiral stationary phases very stable, for applications in routine chromatographic analysis. Furthermore this method makes it possible to control the order of elution of the enantiomers as a function of the target used in the selection of the aptamers.

1.-21. (canceled)

22. A chiral stationary phase for separating enantiomers, comprising an inert solid support to which a chiral selector is bound, characterized in that the chiral selector is an optically active nucleic acid that has an affinity for one of the enantiomers to be separated.

23. A chiral mobile phase for separating enantiomers, comprising a liquid migration buffer and a chiral selector in solution in said buffer, characterized in that the chiral selector is an optically active nucleic acid that has an affinity for one of the enantiomers to be separated.

24. The chiral stationary phase or the chiral mobile phase as claimed in claim 22, characterized in that the chiral selector is an oligonucleotide comprising from 10 to 60 nucleotides.

25. The chiral stationary phase or the chiral mobile phase as claimed in claim 22, characterized in that the chiral selector is a DNA.

26. The chiral stationary phase or the chiral mobile phase as claimed in claim 25, characterized in that the chiral selector is an L-DNA.

27. The chiral stationary phase or the chiral mobile phase as claimed in claim 22, characterized in that the chiral selector is an RNA.

28. The chiral stationary phase or the chiral mobile phase as claimed in claim 27, characterized in that the chiral selector is an RNA comprising modified bases that makes said RNA nuclease-resistant.

29. The chiral stationary phase or the chiral mobile phase as claimed in claim 27, characterized in that the chiral selector is an L-RNA.

30. The chiral stationary phase as claimed in claim 22, characterized in that the inert solid support is functionalized with streptavidin, and in that the chiral selector is a biotinylated nucleic acid.

31. The chiral stationary phase as claimed in claim 30, characterized in that the inert solid support consists of polystyrene-divinylbenzene particles functionalized with streptavidin.

32. A method of preparing a chiral stationary phase for separating enantiomers, comprising the following steps:
a) an optically active nucleic acid that has an affinity for one of the enantiomers to be separated is selected by in vitro amplification and selection on said enantiomer,
b) the nucleic acid selected in step a) is bound to an inert solid support so as to obtain a chiral stationary phase.

33. The method of preparing a chiral stationary phase for separating enantiomers as claimed in claim 32, characterized in that, in step a), a D-DNA is selected and, in step b), the L-DNA having the same sequence is bound to an inert solid support so as to obtain a chiral stationary phase.

34. The method of preparing a chiral stationary phase for separating enantiomers as claimed in claim 32, characterized in that, in step a), a D-RNA is selected and, in step b), the L-RNA having the same sequence is bound to an inert solid support so as to obtain a chiral stationary phase.

35. The method of preparing a chiral stationary phase for selecting enantiomers as claimed in claim 32, characterized in that, in step b), the nucleic acid is biotinylated, and the inert solid support is functionalized with streptavidin allowing binding of the nucleic acid to the inert solid support.

36. A method of preparing a chiral mobile phase for separating enantiomers, characterized in that it comprises the following steps:
a) an optically active nucleic acid that has an affinity for one of the enantiomers to be separated is selected by in vitro amplification and selection on said enantiomer,
b) the nucleic acid selected in step a) is dissolved in a liquid migration buffer so as to obtain a chiral mobile phase.

37. The method of preparing a chiral mobile phase for separating enantiomers as claimed in claim 36, characterized in that, in step a), a D-DNA is selected and, in step b), the L-DNA having the same sequence is dissolved in a liquid migration buffer so as to obtain a chiral mobile phase.

38. The method of preparing a chiral mobile phase for separating enantiomers as claimed in claim 36, characterized in that, in step a), a D-RNA is selected and, in step b), the L-RNA having the same sequence is dissolved in a liquid migration buffer so as to obtain a chiral mobile phase.

39. A method of separating enantiomers, that comprises bringing the enantiomers into contact with a chiral stationary phase or a chiral mobile phase comprising a chiral selector and collecting at least one enantiomer, characterized in that the chiral selector is an optically active nucleic acid that has an affinity for one of the enantiomers to be separated.

40. The method of separating enantiomers as claimed in claim 39, characterized in that the chiral selector is an oligonucleotide comprising from 10 to 60 nucleotides.

41. The method of separating enantiomers as claimed in claim 39, characterized in that the chiral selector is a DNA.

42. The method of separating enantiomers as claimed in claim 41, characterized in that the chiral selector is an L-DNA.

43. The method of separating enantiomers as claimed in claim 39, characterized in that the chiral selector is an RNA.

44. The method of separating enantiomers as claimed in claim 43, characterized in that the chiral selector is an RNA comprising modified bases that makes said RNA nuclease-resistant.

45. The method of separating enantiomers as claimed in claim 43, characterized in that the chiral selector is an L-RNA.
